(19) United States
(12) Patent Application Publication
(10) Pub. No.: US 2003/0099522 A1
(43) Pub. Date: May 29, 2003

(54) Device for mechanically rough machining and/or finish machining cast parts

(76) Inventor: Joachim Laempe, Raich (DE)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/258,649

(22) PCT Filed: Mar. 23, 2001
(86) PCT No.: PCT/EP01/03231

(30) Foreign Application Priority Data
Apr. 28, 2000 (DE) 10020879.7

(51) Int. Cl. B23D 7/08

(52) U.S. Cl. 409/224

(57) ABSTRACT

The invention relates to a device (1) for mechanically rough and or finish machining workpieces, especially flash trimming cast parts. The device has at least one multiaxial robot (2) or manipulator for this purpose. The robot or manipulator supports at least one tool for machining workpiece(s). The device (1) is also provided with a clamping device (5) for holding the workpiece or cast part to be machined. The provision of a magazine (6) for multiple exchangeable tools is also advantageous. The process of changing tools on the robot (2) is preferably program-controllable. At least two clamping devices (5) are preferably provided on a common support device (7), facing away from each other, the support device (5) being located in an approximately vertical plane and being able to pivot or rotate about an axis extending between the two clamping devices (5), so that while one workpiece or cast part is being machined, a new workpiece or cast part can be clamped on the opposite side and this workpiece changeover point is separate and shielded from the machining point.

The invention relates to a device for the mechanically rough machining and/or finish machining of cast parts, for example for flash trimming and/or for the removal of casting channels or risers, with at least one multi-axis robot or manipulator which supports at least one tool for machining the cast part(s), and with a clamping device for the cast part(s) and also preferably a magazine for plural interchangeable tools.

Such a device is known in practice. A robot supports tools, each of which respectively has its own drive, on a displaceable arm. This means a high expense for its manufacture and a high cost, and makes the changing of such tools difficult and time consuming. In particular, an expensive connecting flange between the drive of the tool and the robot arm is required, with which the respective energy required for driving the tool is provided via a coupling and can also be supplied on coupling and connecting with the tool.

Furthermore, such a device is considered to be uneconomic, since after machining a casting or workpiece, a time loss occurs for exchange with the next casting to be machined. Furthermore, when changing the tool, as is possibly required for different kinds of machining, care must be taken that the robot cannot in any circumstances be inadvertently set in operation, which would mean a considerable risk of injury or even risk to the life of the person performing the tool change.

Devices of another kind, particularly for removing flashing or deburring castings, are also already known, in which expensive special machines are provided which carry numerous driven tools, particularly drilling spindles, which are fixedly installed and are adapted and arranged arranged about vertical plane in the use position, and is pivotable or rotatable about an axis that extends between the clamping devices.

It is possible in this manner, during the machining of a workpiece or casting situated in the working position, to unclamp a cast part situated on the clamping device which is pivoted or rotated out of the machining region, and to replace it with the next part to be machined. After the completion of the machining of a cast part, the support device can for example be rotated or pivoted through 180°, and the next machining process can be performed after this. Thus practically no time is lost due to the changing of the cast part to be machined, since such a change of the cast part to be machined can be respectively performed during the machining of such a cast part. Furthermore, the cast part to be machined can be changed at a station which is turned away from the machining station and thus from the robot and the tool carried by this, and is screened off by the support device and also by the clamping device situated thereon, so that there is no risk of accident to the operator who changes the respective cast part. The clamping devices are therefore turned away, and/or separated, from one another on the support device.

Due to the vertical arrangement of the support device for the clamping devices, these are held and mounted in a manner such that a part detached from a cast part during rough or finish machining cannot fall onto the support device or onto the clamping device.

It is appropriate here for the support device with the clamping devices to be pivotable or rotatable through at least 180°. Thus each displacement through this angle results in an allocation of a clamping device to a corresponding location, even when the rotation is performed in the same direction and not alternatively in the one and the other direction, although both of these can be possible.

The support device can be formed from a plate, especially a transparent plate, projecting beyond the clamping devices at least toward one side, and screening from each other a machining station and a station for changing the cast parts on the clamping device. An operator, or even an unauthorized person, can thereby be prevented from reaching a clamping device in the machining region.

Even better screening against possible inadvertently falling parts can be attained if the support device is formed as a plate that projects beyond the clamping device on several or all sides. The more that the plate formed as the support device extends on all sides beyond the clamping devices, the better the screening is between the working region, in which the robot with the tool is arranged, and the station where an operator replaces a machined part with an unmachined cast part on the clamping device.

It is advantageous if the axis serving for the rotation or pivoting of the support device is vertical, and in particular runs through the middle between opposed clamping devices. The masses to be moved when rotating or pivoting can thereby be kept in good equilibrium, which facilitates rotatability so that it can be performed by hand instead of with the aid of a drive motor.

The clamping devices can in their turn be rotatable on the support device or plate; for example, they can be arranged on a turret. The adaptability of the device to different cast parts is thereby improved, since these are also changed in their position relative to the robot during machining, and different regions on the cast part are thereby made more accessible to the robot and its tool. Furthermore, an adaptation to different cast parts and the requirements for clamping them is thereby possible. The device can by used with corresponding versatility.

It can be favorable here if the clamping devices are mounted to be rotatable about a horizontal axis and/or pivotable about a vertical axis. Thus if necessary even back side regions of the cast parts held by the clamping devices, at first facing the support device, can be made accessible and reachable for the tool and the robot without having to unclamp the cast part, which would however also—after a possible rotation of the support device, performed in between—be possible in case it is required.

It is favorable here if the clamping device is arranged on the support device at a distance from the floor, and there is a free space under it. This gives the possibility of also machining a workpiece fastened to the clamping device from below, and/or a transporting device, for example, a conveyor belt can be provided with which residual pieces such as casting channels or risers can be transported away.

The clamping device can have a clamping surface which is vertical or possibly inclined and downwardly-directed. Thus, a casting clamped thereon can stand out generally horizontally from the clamping device and from the support device, so that it is easily accessible from all sides for one or more tools of the robot. A cast part can be rough and finish machined correspondingly economically and without, or with few, resetting devices.

In order to be able to effectively machine diverse cast parts, or differently arranged places on a casting, in the best possible manner, and without unclamping the cast part, it is appropriate if the robot arranged within reach of a clamping device facing toward it has at least six axes. Correspondingly many degrees of freedom are present on the tool carried by this robot.

The robot can have at least one gripper on its arm, in addition to a receiving device for the, particularly interchangeable, tools, with the gripper being displaceable by the robot to the clamping device facing it and/or the cast part gripped by it, and serving to grip and unclamp the cast part. Thus if a complicated cast part is to be machined using the robot, and in this case requires unclamping, this can be performed by the robot itself, instead of the support device being rotated and the unclamping then being carried out. By the measure of providing the arm of the robot with an additional gripper, the flexibility and adaptability of the whole device for the most diverse machining requirements is thus improved.

A further embodiment of the invention for enlarging its effectiveness is provided in that at least two support devices with clamping devices for cast parts to be machined or like workpieces are arranged within reach of the robot. The robot can then machine in succession at least two cast parts or workpieces situated within its reach, without the support device having to be rotated or pivoted in between, so that operators also have correspondingly more time for changing such cast parts on the clamping devices as long as these are turned away. The economic value of the device can thus be increased.

An additional or modified embodiment can include a support device that has at least two clamping devices on both sides of its midplane running through the rotation axis, and thus has in all at least four clamping devices. There are then also at least two clamping devices, and thus also two cast parts or workpieces, facing the robot, which it can machine partially in succession and partially, if necessary, simultaneously, while on the side turned away, just as many cast parts or workpieces can be changed.

A further modification of the invention is provided in that the support device, in a cross section running at right angles to its rotation axis, is generally star-shaped, and forms at least three screens standing at an angle, in particular at a coincident angle, between which clamping devices for cast parts are arranged, so that a rotation of the support device serves to further displace a clamping device by about 120°. Such an arrangement is helpful when the machining times on the one hand, and the times for exchanging a machined workpiece for one yet to be machined differ considerably from one another or fluctuate, so that nevertheless the next cast part can be rotated into the region of the robot in each case after a finishing machining.

The robot can have at the free end of its arm a fixedly installed spindle motor for driving the respectively releasably attachable and interchangeable tools. Thus, only tools with relatively low weight have to be interchanged, and not a unit consisting of a tool and a drive, when machining with different tools has to be performed, for example on one and the same cast part, or after the machining of one cast part another is to be machined for which other tools are required. The tool change can thereby be rationalized and simplified. Moreover, substantially less expensive tools can be used. Finally, the multiplicity of the tools which can be used is increased.

Furthermore, a further embodiment is thereby possible, to the effect that the spindle motor or drive motor located on the robot arm can have two drives for the simultaneous installation of two tools. Thus two tools can simultaneously perform a secondary machining, or else can be brought into effect one shortly after the other, without a tool change having to be performed.

The drive portion of the drive motor can be moved back on the arm of the robot and the tool drive from this can have a smaller dimension or more slender shape than the seating of the drive motor, with the interchangeable tool arranged in its prolongation. This gives a slender shape for the tool drive proper which is appropriately located in a coaxial extension of the tool, so that the tool can be used even at deeply situated or poorly accessible regions of the cast part without being hindered by the relatively voluminous drive motor or its housing. If necessary, the tool drive from the drive motor proper, for example a spindle, can also be deliberately made long, in order to be able to reach deep-lying or hidden places on a workpiece.

Above all, with a combination of individual or several of the above-described features and measures, a device results for the machining of cast parts or other comparable workpieces such as semi-finished goods, welded structures or also other components, with the device being very economical and effective, and the operator being screened from the working region of the robot when changing the workpiece. At the same time, this robot, with a small constructional volume because of the drive fixedly installed on it for the tools, can have a high performance and makes possible the use of numerous different interchangeable tools, which are provided in a corresponding magazine belonging to the device and can be programmably started off in order to respectively interchange them.

A spindle of the tool drive can thus be combined with an automatic tool change chucking system.

If necessary, at least one robot or manipulator can be provided instead of the operator who clamps and unclamps the castings or workpieces, so that then corresponding robots or manipulators can operate, screened from one another, on both sides of the support device.

Preferred embodiments of the invention are described in detail hereinafter, using the accompanying drawings, which include partially schematized diagrams.

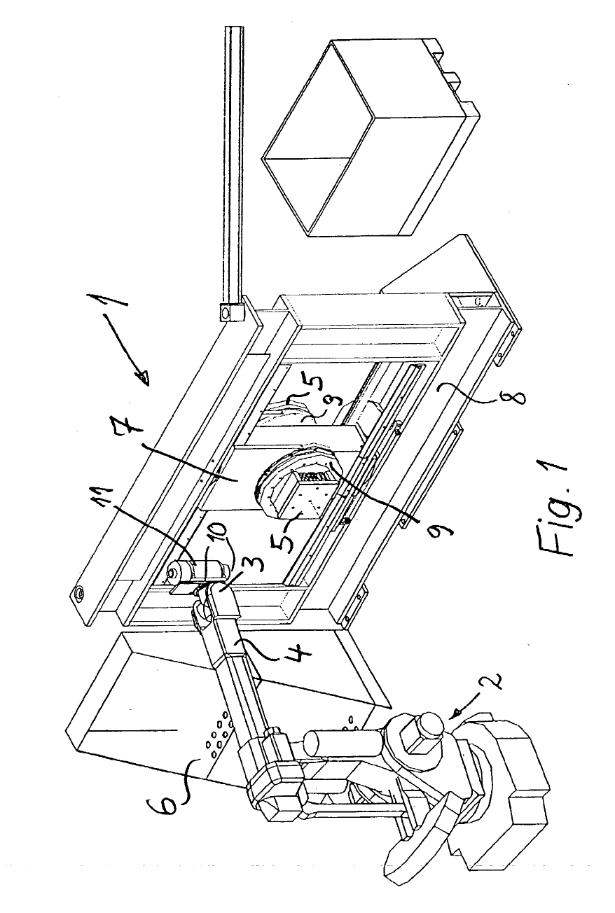

FIG. 1 is a diagrammatic view of the device according to the invention with a common support device for two clamping devices arranged facing one another thereupon, and on the machining side with a robot which can machine a workpiece or casting with different tools and for this purpose also has a magazine for interchangeable tools,

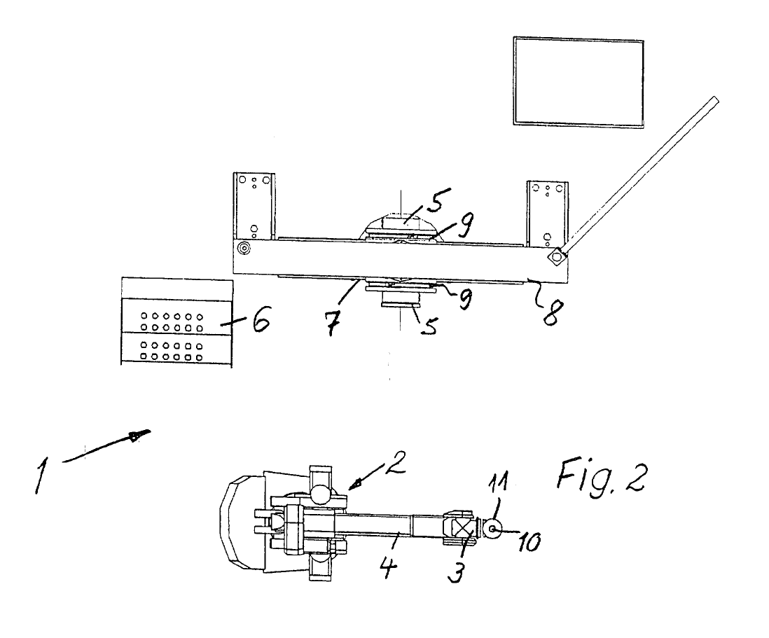

FIG. 2 is a top view of the device shown in FIG. 1 and the arrangement of the parts belonging to the device,

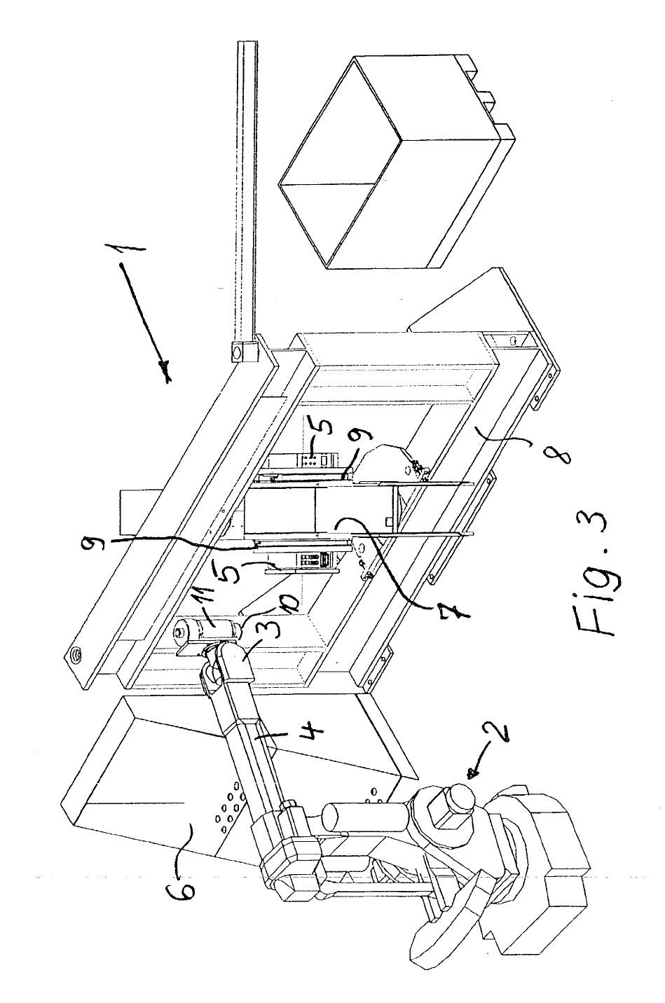

FIG. 3 is a diagram corresponding to FIG. 1, the support device with the clamping devices being partially rotated about a vertical axis directly for changing a workpiece or a cast part, so that a clamping device previously turned away from the robot comes into its working region, and the clamping device previously in the region of the robot is moved away from it with a machined cast part, so that the machined cast part can be furthermore be exchanged for one not yet machined.

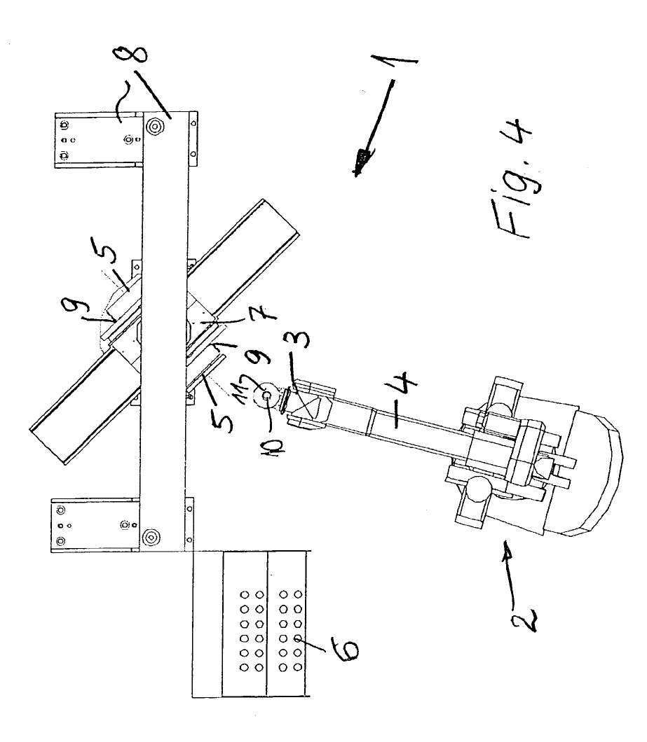

FIG. 4 is a top view of the arrangement shown in FIG. 3, with a partially rotated support device.

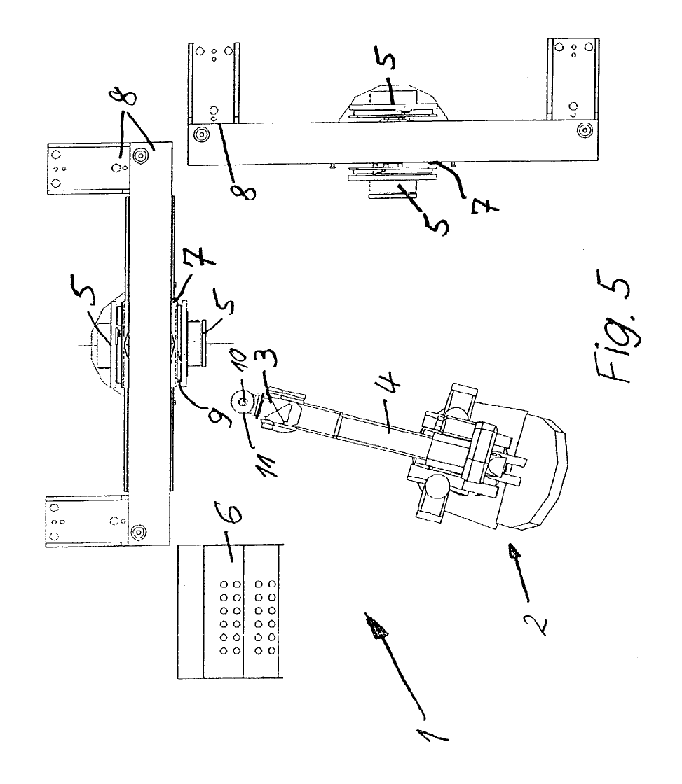

FIG. 5 is a diagram and arrangement corresponding to FIG. 2, of a second support device with two respective clamping devices being provided, so that the robot can machine in succession double the number of cast parts,

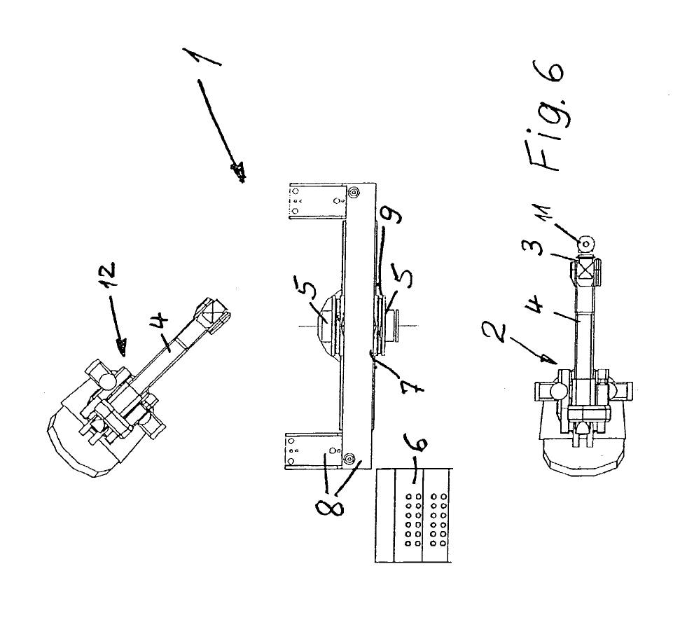

FIG. 6 is an arrangement according to FIG. 2, wherein a robot or manipulator for exchanging the cast parts on the clamping device is provided on the side of the support device turned away from the machining robot,

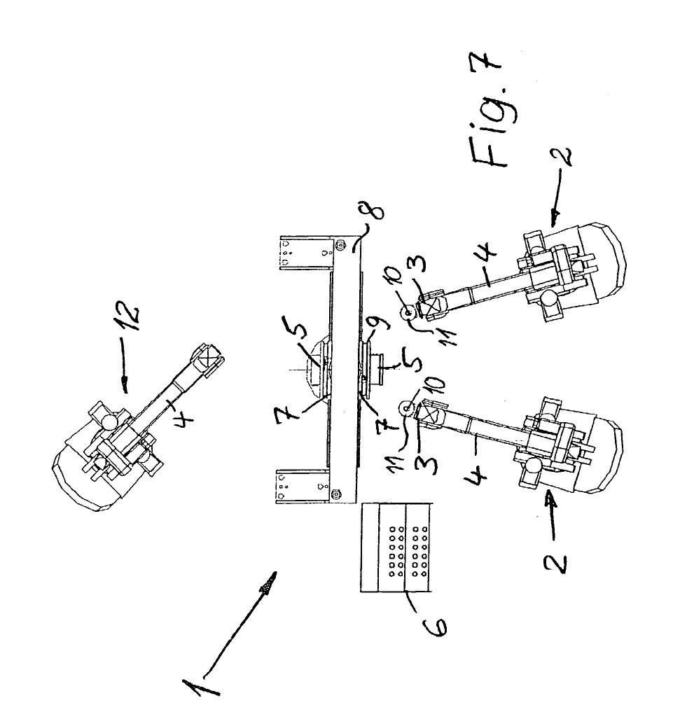

FIG. 7 is an arrangement corresponding to FIG. 6, in which two robots are arranged on the machining side of the support device, and can simultaneously or successively machine one and the same cast part, for example with different tools.

A device indicated as a whole by 1 serves for the mechanically rough machining and/or finish machining of workpieces, particularly of cast parts, which for example have to be deburred after removal from the mold.

The device 1 includes at least one multi-axis robot or manipulator that is also simply termed “robot 2” hereinafter, and bears at the free end 3 of its arm 4, which is movable in different directions, at least one tool, not shown in detail, for machining the cast part(s).

Furthermore, the device 1 includes clamping devices 5 1 for clamping the cast part to be machined, and also in the embodiment example at least one magazine 6 for plural interchangeable tools, which can respectively be selectively installed at the end of the arm 4 of the robot 2 and can also be changed in a programmed manner by the robot 2 itself.

A common support device 7 for at least two clamping devices 5 can be seen particularly well in FIG. 1 and above all in FIGS. 3 and 4, and in the use position is arranged with these clamping devices 5 in a generally vertical plane and is pivotable or rotatable around an imaginary axis running between the clamping devices 5. By simultaneous observation of FIGS. 1 and 3, or 2 and 4, it can be seen how the support device 7 is rotatable with respect to a machine frame 8, so that the clamping devices 5 can be brought into different positions at any given time.

In this embodiment example, the support device 7 is pivotable or rotatable by at least 180° with respect to the machine frame 8, so that the one clamping device 5 can be brought into the place of the other and vice versa, in order to be able to machine and deburr a cast part held by a clamping device 5 respectively on the side of the robot 2, while at the other clamping device 5 an already machined cast part is unclamped and one yet to be machined is clamped.

Here the support device 7 is formed as a plate projecting at least on one side, particularly above and below, beyond the clamping devices 5, and separating and screening from one another the machining station on the side of the robot 2, and the station serving for changing the cast parts. The exchanging of a machined cast part for one yet to be machined thus takes place at a station which cannot by reached, even inadvertently, by the robot 2. It is favorable here if the support device 7 is formed particularly as a transparent plate or as a transparent plastic plate, or there can appropriately be an opening with a window laterally of the clamping devices 5 so that it remains possible to look through from one side to the other of the support device 7.

It is clear from FIGS. 1-4 that the axis for rotation or pivoting of the support device 7 extends vertically, so that the rotation can run easily and without appreciable mass balancing. Also, the weights of the support device 7, the clamping devices 5 and the workpieces held by them can be better transmitted to the machine frame 8 or a foundation.

For the best possible accessibility to a workpiece or cast piece fastened to a clamping device 5, the clamping devices 5 are in their turn arranged on a turret 9, that is rotatable relative to the support device 7, and can thus be rotated about a horizontal axis. In addition, however, a further possibility of pivoting around a vertical axis would also be possible.

It is furthermore provided in the embodiment examples that the clamping device 5 is arranged on the support device 7 at a distance from the floor on which the machine frame 8 rests, and accordingly there is a free space under it, so that a workpiece fixed to the clamping device 5 is also accessible from below, and parts separated from it can fall down freely. The free space permits on the one hand the accessibility from below, as mentioned, and on the other hand the installation of, for example, a conveyor belt in order to be able to transport detached parts away without problems. It can further be seen that the clamping device 5 has a vertical clamping surface in the disclosed embodiments, although this could also extend inclined. Thus, a workpiece fastened to the clamping device projects generally horizontally from the clamping device 5 and the support device 7, and has the best possible accessibility for the robot 2 and its tools.

The robot 2 arranged within reach of the clamping device 5 facing it is provided with six axes in the disclosed embodiment, in order to be able to perform different kinds of machining on the respective cast part. In a manner not shown in detail, the robot 2 can have, in addition to a seating device 10 for the interchangeable tool(s), at least one gripper at the forward end 3 of its arm 4 and displaceable by the robot 2 toward the clamping device 5 facing it and the cast part gripped thereby, and could be used for gripping and unclamping the cast part.

An embodiment example is shown in FIG. 5 in which two support devices 7 with a machine frame 8 and clamping devices 5 for cast parts are arranged within reach of the robot 2, so that above all simpler cast parts can be rapidly and accurately finished and respectively exchanged after the rotation of the support devices 7. However, it would also be possible for a support device 7 to have, on both sides of its midplane running through the midplane, at least two additional clamping device 5, thus in all four such clamping devices 5, in order to be able to attain a similar effect. If necessary, a machine frame 8 could also contain here two rotatable support devices 7.

The robot 2 has at the free end 3 of its arm 4 a fixedly installed spindle motor or drive motor 11 for driving the respective releasably attachable and interchangeable tools. Thus, very simple conventional tools can be selectively attached without their drive having to be interchanged also. If necessary, the spindle- or drive motor 11 situated at the end of the robot arm 4 can also have two drives for the simultaneous attachment of two tools, for example, at its two mutually opposed ends.

In FIG. 6, an embodiment is shown with the robot 2 and the support device 7, in which a further robot 12 is arranged on the side of the support device 7 on which an unmachined casting or cast part is fastened to a clamping device 5, while on the other, turned away, side of the support device 7 a cast part can be machined by the robot 2. The changing of the workpieces can also be automated or mechanized in this manner.

Finally, in FIG. 7 two robots 2 are shown than can also be provided on the machining side, in order to be able to finish expensive cast parts. Here it would naturally be conceivable that plural support devices 7 are also arranged in the region of these robots 2. The unclamping of the finish machined workpieces and their exchanging for such parts to be machined could be performed by the operator or, as shown in FIG. 7, again by a robot 12.

The device 1 serves for mechanically rough and/or finish machining of workpieces, particularly for the deburring of cast parts and/or for detaching or removing casting channels and/or risers from such cast parts, and has for this purpose at least one multi-axis robot 2 or manipulator, which supports at least one tool for the machining of the workpiece(s). The device 1 furthermore includes a clamping device 5 in order to be able to receive the workpiece or cast part to be machined. It is furthermore appropriate if a magazine 6 for plural interchangeable tools is present, and the changing of the tools on the robot 2 can preferably take place via programmable control. At least two clamping devices 5 are provided, remote from one another, on the common support device 7, the support device 7 being arranged in a generally vertical plane and being pivotable or rotatable about an axis extending between these clamping devices 5, so that during the machining of one workpiece or cast part, a new cast part or workpiece can be clamped on the side turned away, and this station for workpiece changing is separated and screened from the machining station.

1. Device (1) for the mechanical rough machining and/or finish machining of cast parts, for example for deburring and/or for removal of casting channels or risers, with at least one multi-axis robot (2) or manipulator, which supports at least one tool for the machining of the cast part(s), and with a clamping device (5) for the cast part(s), and also preferably with a magazine (6) for plural, interchangeable tools, characterized in that at least two clamping devices (5) for cast parts are provided on a common support device (7); wherein the support device (7) for these clamping devices (5) in the use position is arranged in a generally vertical plane and is pivotable or rotatable around an axis that extends between the clamping devices (5).

2. Device according to claim 1, characterized in that, the support device (7) with the clamping devices (5) is pivotable or rotatable at least 180°.

3. Device according to claim 1 or 2, characterized in that, the support device is formed as, in particular, a transparent plate or the like which projects beyond the clamping devices (5) at least on one side, and which screens from one another a machining station and a station serving for exchanging the cast parts on the clamping device (5).

4. Device according to one of claims 1-3, characterized in that, the support device (7) is formed as, in particular, a transparent plate or the like, projecting beyond the clamping devices (5) on plural or all sides.

5. Device according to one of claims 1-4, characterized in that, the axis for rotation or pivoting of the support device (7) extends vertically.

6. Device according to one of claims 1-5, characterized in that, the clamping devices (5) are each, respectively, rotatable, for example, arranged on a turret, on the support device (7) or plate.

7. Device according to one of claims 1-6, characterized in that, the clamping devices (5) are rotatable around a horizontal axis with respect to the support device (7) and/or mounted pivotably about a vertical axis.

8. Device according to one of claims 1-7, characterized in that, the clamping device (5) is arranged on the support device (7) at a distance from the floor with a free space thereunder.

9. Device according to one of claims 1-8, characterized in that, the clamping device (5) has a vertical or possibly inclined or downwardly-directed clamping surface.

10. Device according to one of claims 1-9, characterized in that, the robot (2) within reach of the clamping device (5) facing it is provided with at least six axes.

11. Device according to one of claims 1-10, characterized in that, the robot (2) has at the end (3) of its arm (4), in addition to a seating device (10) for the in particular interchangeable tool(s), at least one gripper, which is displaceable by the robot (2) toward the clamping device (5) facing it and/or the cast part gripped thereby, and serves for gripping and unclamping the cast part.

12. Device according to one of claims 1-11, characterized in that, at least two support devices (7) with clamping devices (5) for cast parts are arranged within reach of the robot (2).

13. Device according to one of claims 1-12, characterized in that, a support device (7) has, on both sides of a midplane extending through the rotation axis, at least two clamping devices (5), so that there is a total of at least four clamping devices (5).

14. Device according to one of claims 1-13, characterized in that, the support device (7), is generally star-shaped in a cross section running at right angles to its rotation axis, and forms at least three screens standing at an angle, in particular at a congruent angle, between which clamping devices (5) for cast parts are arranged, so that a rotation of the support device (7) respectively by about 12° serves for further displacement of a clamping device (5).

15. Device according to one of claims 1-14, characterized in that, the robot (2) has at the free end (3) of its arm (4) a fixedly installed drive motor or spindle motor (11) for driving the respective releasably attachable and interchangeable tools.

16. Device according to one of claims 1-15, characterized in that, the spindle- or drive motor (11) situated on the robot arm (3) has two drives for the simultaneous attachment of two tools.

17. Device according to one of claims 1-16, characterized in that, the drive portion of the drive motor (11) can be moved back on the end (3) of the arm (4) of the robot (2) and the tool drive from this can have a smaller dimension or a slender shape than the seating of the drive motor (11), with the interchangeable tool arranged in its prolongation.
